(19) United States
(12) Patent Application Publication
(10) Pub. No.: US 2019/0010894 A1
(43) Pub. Date: Jan. 10, 2019

(54) Gas turbine having a high-speed low-pressure turbine and a turbine case

(71) Applicant: MTU Aero Engines AG, Muenchen (DE)

(72) Inventors: Guenter RAMM, Eichenau (DE); Reinhold SCHABER, Ottobrunn (DE)

(21) Appl. No.: 16/027,472

(22) Filed: Jul. 5, 2018

(30) Foreign Application Priority Data
Jul. 7, 2017 (DE) DE102017211649.8

(51) Int. Cl. F02K 1/04; F02K 3/06

(52) U.S. Cl. CPC F02K 1/04; F02K 3/06; F05D 2270/20; F05D 2240/14; F05D 2260/40; F05D 2220/323

(57) ABSTRACT

A gas turbine (40) having a high-speed low-pressure turbine (24) and a turbine case (28) that bounds a flow path of a working fluid of the gas turbine (40) and an exit region (30), and extends between a rotor (32) of the high-speed low-pressure turbine (24) that is the most downstream in the through flow direction of the working fluid, and an exit opening (34) of the turbine case (28). The exit region (30) is designed to be free of exit guide vane assemblies.

This claims the benefit of German Patent Application DE 10 2017 211 649.8 filed Jul. 7, 2017 and hereby incorporated by reference herein.

The present invention relates to a gas turbine, including a high-speed low-pressure turbine and a turbine case.

### BACKGROUND

A gas turbine having what is generally referred to as a geared turbofan has the distinguishing feature that the components, fan and low-pressure turbine, are no longer seated on a common shaft, rather are coupled by a gear unit. When the fan driven by the low-pressure turbine or an impeller driven by the low-pressure turbine rotates more slowly during operation of the gas turbine than the low-pressure turbine, this is referred to as a high-speed low-pressure turbine. In the case of high-speed low-pressure turbines of gas turbines, what is generally referred to as an exit guide vane assembly is installed downstream of the most downstream rotor of the low-pressure turbine to remove the swirl from the flow prior to the working fluid exiting from a turbine case. The exit guide vane assembly is a most downstream, respectively, in the through flow direction of the working fluid, the last or the last of a plurality of the vane assemblies that are axially serially disposed in the through flow direction of the turbine. The exit guide vane assembly can be configured, in particular as what is generally referred to as an outlet guide vane assembly for a turbine exit. Therefore, such a turbine case is also referred to as turbine exit case (TEC). Besides structural aspects, the purpose of a TEC in aircraft engines is first and foremost to ensure a swirl-free exit flow and thus an excellent thrust efficiency during cruising operation.

However, the pressure loss that occurs because of the exit vane assembly leads to an increase in fuel consumption. Moreover, such exit guide vane assemblies are relatively heavy components that require correspondingly stable bearing structures and, moreover, cause acoustic problems due to the relatively low blade count thereof.

### SUMMARY OF THE INVENTION

It is an object of the present invention to provide a gas turbine of the aforementioned type that will be reduced in weight and have improved fuel consumption and noise emission characteristics.

The present invention provides a gas turbine that is reduced in weight and has improved fuel consumption and noise emission characteristics by configuring the exit region of the turbine case to be free of exit guide vane assemblies. In other words, in accordance with the present invention, the gas turbine does not have any exit guide vane assembly or outlet guide vane assembly. Surprisingly, it turns out that dispensing with an exit guide vane assembly does initially lead to a somewhat lower efficiency of the entire gas turbine since the flow exiting the low-pressure turbine does have greater swirl if no appropriate countermeasures are taken. However, this loss in efficiency is at least substantially compensated by the elimination of the pressure loss of the exit guide vane assembly. Further improvements in consumption are achieved because of the weight saved by omitting the exit guide vane assembly and because of the possibility of also economizing on bearing structures. Advantages are also unexpectedly attained in the acoustic characteristics of the gas turbine. Moreover, eliminating the exit guide vane assembly also minimizes the limitations in the number and design of the rotor blades of the last, respectively most downstream rotor of the low-pressure turbine, whereby unexpected efficiency enhancements may likewise be realized along with a correspondingly reduced fuel consumption. The gas turbine may be configured as an aircraft engine or as a stationary turbine, for example.

Another advantageous embodiment of the present invention provides that the gas turbine be designed as a turbofan engine. In the case of a turbofan engine, which is also referred to as a bypass engine, an outer or secondary fluid flow surrounds an inner primary or core flow that participates in the actual thermodynamic cycle of the gas turbine, to which the high-speed low-pressure turbine also contributes as part of the core engine. The bypass flow reduces the velocity of the working fluid, whereby, during operation, a lower fuel consumption and lower noise emissions are realized in comparison to a single-flow jet engine of the same thrust power.

Another advantageous embodiment of the present invention provides that the gas turbine have a bypass ratio of bypass flow to primary flow of at least 1.5:1. The primary flow is thereby the inner flow of the working fluid, while the bypass flow is also referred to as secondary flow or outer flow. Together, the secondary and primary flow produce the total thrust power. Since, with increasing bypass ratio, the core engine in a turbofan engine contributes less and less to the total thrust of the turbomachine, losses in the primary flow downstream of the low-pressure turbine hardly affect the overall fuel consumption of the turbomachine. A bypass ratio of at least 1.5:1 is understood to include bypass ratios of 1.5:1, 2.0:1, 2.5:1, 3.0:1, 3.5:1, 4.0:1, 4.5:1, 5.0:1, 5.5:1, 6.0:1, 6.5:1, 7.0:1, 7.5:1, 8.0:1, 8.5:1, 9.0:1, 9.5:1, 10.0:1, 10.5:1, 11.0:1, 11.5:1, 12.0:1, 12.5:1, 13.0:1, 13.5:1, 14.0:1, 14.5:1, 15.0:1 or greater. For that reason, losses in the primary flow have less of an effect on the overall fuel consumption of the gas turbine.

Further advantages will become apparent as the gas turbine has a rotatable exit cone (core cowl) in the area of the high-speed low-pressure turbine. This makes it possible to avoid a sudden or abrupt change in the exit cross section of the flow duct and, instead, for it to be continuously widened by eliminating the exit guide vane assembly. The exit flow may thereby be retarded in a manner that is free of separation or at least virtually free of separation, making it possible to further enhance efficiency.

Another advantageous embodiment of the present invention provides that the gas turbine have a fan that is coupled via a reduction gear to the high-speed low-pressure turbine. Selecting a suitable speed reduction ratio makes it possible for the fan and the high-speed low-pressure turbine to run at the respective physical optimum thereof during operation of the gas turbine with the aid of the reduction gear, thereby economizing on fuel and reducing the noise level. The additional mass of the reduction gear is compensated by a lower mass of the high-speed turbine.

Another advantageous embodiment of the present invention provides that the high-speed low-pressure turbine be configured downstream of a combustion chamber and/or downstream of a single- or multi-stage high-pressure or intermediate-pressure turbine, relative to the flow path of the working fluid. Correspondingly high power output levels may be realized by using two or more partial turbines.

Further advantages are derived as the high-speed low-pressure turbine is designed as a single- or multi-stage low-pressure turbine. The turbine may be hereby optimally adapted to the respective intended purpose thereof.

Another advantageous embodiment of the present invention provides that, relative to the through flow direction of the working fluid, the most downstream rotor be configured in such a way that, during operation of the gas turbine, an average exit swirl angle of the working fluid be at most ±15° relative to an axis of the high-speed low-pressure turbine. In other words, it is provided that, considered in the direction of flow, the most downstream, respectively the last rotor be configured in such a way that, during normal operation of the high-speed turbine, a smallest possible average exit swirl angle of, at most, ±15° results. This means, for example, of ±15°, ±14°, ±13°, ±12°, ±11°, ±10°, ±9°, ±8°, ±7 °, ±6°, ±5°, ±4°, ±3°, ±2°, ±1° or less relative to the axis of the turbine, respectively the axis of rotation of the rotor.

### BRIEF DESCRIPTION OF THE DRAWINGS

Other features of the present invention will become apparent from the claims, the figures, and the detailed description. The features and feature combinations mentioned above in the description as well as the features and feature combinations mentioned below in the detailed description and/or shown in isolation in the figures may be used not only in the respectively specified combination, but also in other combinations without departing from the scope of the present invention. Thus, embodiments of the present invention that are not explicitly shown and described in the figures, but derive from and may be produced by separate feature combinations from the explained embodiments, are also considered to be included and disclosed herein. Embodiments and combinations of features are also considered to be disclosed herein that, therefore, do not have all the features of an originally formulated independent claim. Moreover, variants and combinations of features are also considered to be disclosed herein in particular by the explanations described above that go beyond the combinations of features described in the antecedent references of the claims or that deviate therefrom. In the drawing,

FIG. 1 shows a schematic cross-section of a non-inventive gas turbine;

FIG. 2 is a schematic representation of an exit region of the gas turbine in accordance with region A shown in FIG. 1;

FIG. 3 is a schematic representation of the exit region of a gas turbine according to the present invention; and

FIG. 4 is a diagram in which a percentage change in the consumption of different turbomachines is plotted on the ordinate over an exit swirl of a working fluid in degrees relative to an axis of the gas turbine.

### DETAILED DESCRIPTION

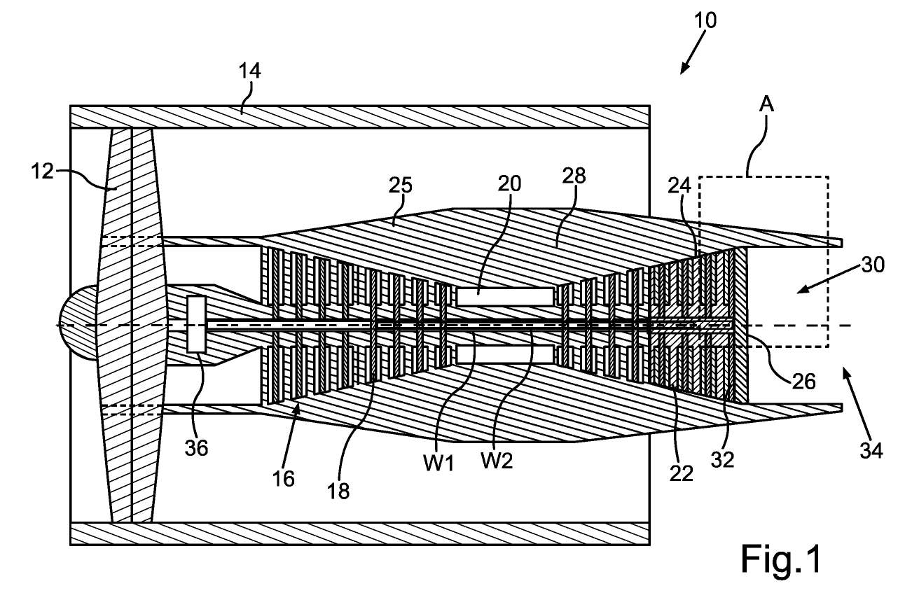

FIG. 1 shows a schematic cross section of a non-inventive gas turbine 10 which, in the present case, is in the form of an aircraft engine. Gas turbine 10 includes a fan 12 that is configured in a fan casing 14. Considered in the direction of flow of the working fluid, fan 12 is followed by a low-pressure compressor 16, a high-pressure compressor 18, a combustion chamber 20, a high-pressure turbine 22, a low-pressure turbine 24 and an exit guide vane assembly 26. Low-pressure compressor 16 and high-pressure compressor 18 are configured in a compressor casing 25, while high-pressure turbine 22 and low-pressure turbine 24 are configured in a turbine case 28. Together, compressor casing 25 and turbine case 28 define a flow path of the working fluid of gas turbine 10. Turbine case 28, in turn, has an exit region 30 that extends between a rotor 32 of low-pressure turbine 24 that is the most downstream in the through flow direction of the working fluid, and an exit opening 34 of turbine case 28. In addition, gas turbine 10 includes a reduction gear 36 via which fan 12 is coupled to low-pressure turbine 24, so that low-pressure turbine 24 may also be referred to as high-speed low-pressure turbine 24.

During operation of gas turbine 10 in the form of a turbofan engine, the total thrust is made up of the primary flow, this means the inner flow of the working fluid that is directed through compressor casing 25 and turbine case 28, and of the bypass flow, the bypass flow also being referred to as secondary flow or outer flow and flowing along the flow path that is formed by fan casing 14, on one side, and compressor casing 25 and turbine case 28, on the other side.

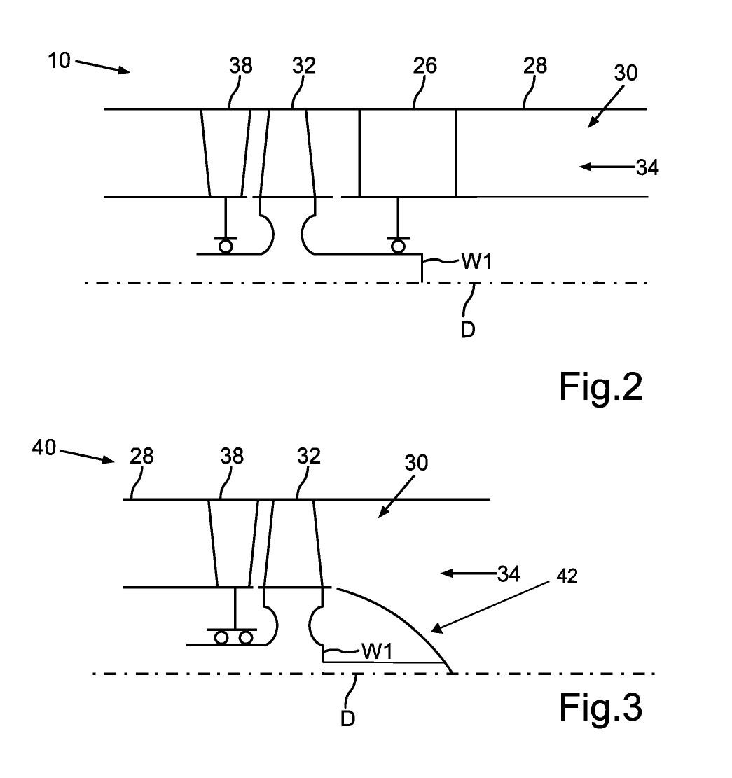

FIG. 2 schematically depicts exit region 30 of gas turbine 10 in accordance with region A shown in FIG. 1. Discernible, in particular, is a guide vane 38 that is fixed relative to turbine case 28 and on which a shaft W1 is rotatably mounted, the most downstream rotor 32 that is connected to shaft W1, respectively the most downstream impeller 32 of low-pressure turbine 24, as well as exit guide vane assembly 26 that is configured in turbine case 28 and is also referred to as outlet guide vane assembly. Shaft W1, which defines an axis of rotation, respectively a center axis D of gas turbine 10, is rotatably mounted on exit guide vane assembly 26 which, in turn, is likewise fixedly mounted on turbine case 28.

FIG. 3 schematically depicts exit region 30 of a gas turbine 40 according to the present invention. The design of gas turbine 40 according to the present invention basically corresponds to that of gas turbine 10 shown in FIGS. 1 and 2. However, in contrast to gas turbine 10, exit region 30 of gas turbine 40 is designed to be free of exit guide vane assemblies. In other words, no exit guide vane assembly or outlet guide vane assembly 26 is provided in exit region 30 between most downstream rotor 32 and exit opening 34. Instead, rotor 32 that is the most downstream relative to the through flow direction of the working fluid, is designed in such a way that, during operation of gas turbine 40, an average exit swirl angle of the working fluid is at most ±15° relative to an axis (D) of high-speed low-pressure turbine 24. In addition, gas turbine 40 has a bypass ratio of at least 1.5:1, thus, for example, of 1.5:1, 2.0:1, 2.5:1, 3.0:1, 3.5:1, 4.0:1, 4.5:1, 5.0:1, 5.5:1, 6.0:1, 6.5:1, 7.0:1, 7.5:1, 8.0:1, 8.5:1, 9.0:1, 9.5:1, 10.0:1, 10.5:1, 11.0:1, 11.5:1, 12.0:1, 12.5:1, 13.0:1, 13.5:1, 14.0:1, 14.5:1, 15.0:1 or greater. Thus, any losses in the primary flow have less of an effect on the overall fuel consumption of gas turbine 40.

To further enhance efficiency, especially advantageous embodiments provide for gas turbine 40 to also include a rotatable exit cone 42, which may also be referred to as “core cowl.” This makes it possible to avoid a sudden or abrupt change in the exit cross section of the flow duct and, instead, for it to be continuously widened. The exit flow may thereby be retarded in a manner that is free of separation or at least virtually free of separation, making it possible to further enhance efficiency.

As illustrated, exit cone 42 may be part of the rotor and/or fixedly connected to an axially last rotor blade ring of low-pressure turbine 24. Accordingly, exit cone 42 may corotate uniformly and together with the last rotor blade ring of low-pressure turbine 24.

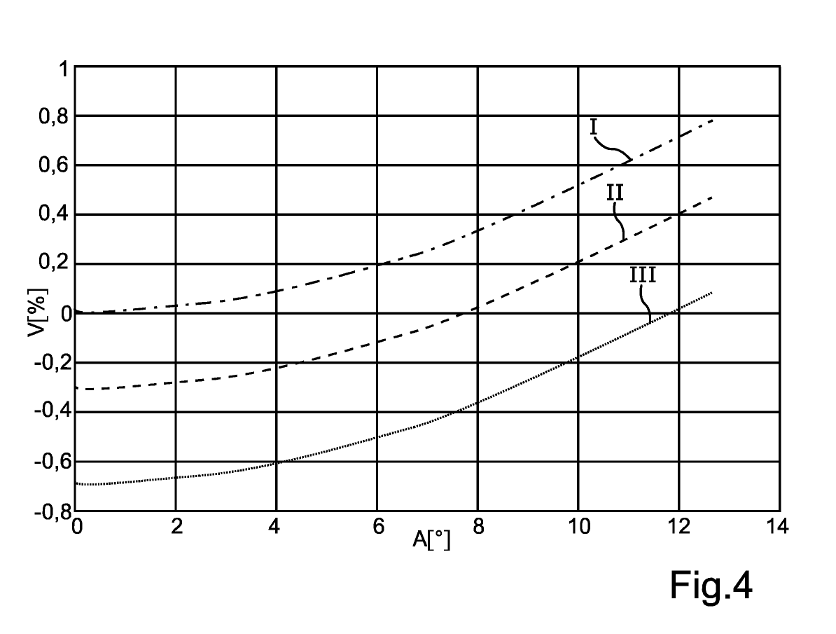

FIG. 4 shows a diagram in which a change in consumption V [%] of different gas turbines 10, 40 is plotted on the ordinate over an exit swirl A [°] of a working fluid in relation to an axis (D) of gas turbine 10, 40 in question. Dash dot curve I thereby exemplarily shows the effect of a non-swirl-free exiting flow on the consumption in the cruise flight for a non-inventive gas turbine 10 in the form of a turbofan engine that includes a high-speed low-pressure turbine 24 having an exit guide vane assembly 26.

The dashed middle curve II shows the same relationship as upper curve I, but for a gas turbine 40 according to the present invention in the form of a turbofan engine that includes a high-speed low-pressure turbine 24 without an exit guide vane assembly 26, respectively without a TEC. It is discernible that eliminating the pressure loss because of the absence of exit guide vane assembly 26 makes it possible to achieve a consumption comparable to that of non-inventive gas turbine 10 (curve I) at an exit flow angle of about 8° and disregarding other effects.

A further fuel saving of approximately 0.4% is achieved, additionally taking into consideration the effect of eliminating the weight of the TEC, respectively of exit guide vane assembly 26, for example, for a redesigned gas turbine 40. This is illustrated by the bottom, dotted curve III (without TEC pressure loss and weight). The manufacturing costs for the TEC, respectively for exit guide vane assembly 26 would still be eliminated even at an exit swirl angle of about 12° and at the same consumption. By eliminating the TEC, a rotatable design of an exit cone (core cowl of high-speed low-pressure turbine 24, respectively of gas turbine 40 may be advantageous.

### REFERENCE NUMERAL LIST

10 gas turbine (non-inventive)
12 fan
14 fan casing
16 low-pressure compressor
18 high-pressure compressor
20 combustion chamber
22 high-pressure turbine
24 low-pressure turbine
25 compressor casing
26 exit guide vane assembly
28 turbine case
30 exit region
32 rotor
34 exit opening
36 reduction gear
38 guide vane
40 gas turbine (inventive)
42 rotatable exit cone
D axis of rotation
W1 shaft
I gas turbine having high-speed low-pressure turbine including an exit guide vane assembly
II gas turbine having high-speed low-pressure turbine without exit guide vane assembly
III gas turbine having high-speed low-pressure turbine without exit guide vane assembly taking weight reduction into consideration

What is claimed is:

1-8. (canceled)

9. A gas turbine comprising:
a high-speed low-pressure turbine; and
a turbine case bounding a flow path of a working fluid of the gas turbine and an exit region extending between a rotor of the high-speed low-pressure turbine, the rotor being a most downstream rotor in a through flow direction of the working fluid, the turbine case having a exit opening;
wherein the exit region is free of exit guide vane assemblies.

10. The gas turbine as recited in claim 9 wherein the gas turbine is a turbofan engine.

11. The gas turbine as recited in claim 10 wherein the turbofan engine has a bypass ratio of bypass flow to primary flow of at least 1.5:1.

12. The gas turbine as recited in claim 9 further comprising a rotatable exit cone in a region of the high-speed low-pressure turbine.

13. The gas turbine as recited in claim 9 further comprising a fan coupled via a reduction gear to the high-speed low-pressure turbine.

14. The gas turbine as recited in claim 9 wherein, relative to the flow path of the working fluid, the high-speed low-pressure turbine is configured downstream of a combustion chamber or downstream of a single- or multi-stage high-pressure or intermediate-pressure turbine.

15. The gas turbine as recited in claim 9 wherein the high-speed low-pressure turbine is configured as a single- or multi-stage low-pressure turbine.

16. The gas turbine as recited in claim 9 wherein the most downstream rotor is designed in such a way that, during operation of the gas turbine, an average exit swirl angle of the working fluid is at most ±15° relative to an axis of the high-speed low-pressure turbine.

17. A method for operating the gas turbine as recited in claim 16 comprising operating the gas turbine so that the average exit swirl angle of the working fluid is at most ±15° relative to the axis of the high-speed low-pressure turbine.

18. A method for operating the gas turbine as recited in claim 9 comprising passing the working fluid through the exit region free of exit guide vane assembly influence.
